(19) United States
(12) Patent Application Publication
(10) Pub. No.: US 2002/0124406 A1
(43) Pub. Date: Sep. 12, 2002

(54) Installation for the circulation of part-carrying pallets and a process for the assembly thereof

(76) Inventors: Jacques Prodel, Carlepont (FR); Annick Prodel, Carlepont (FR)

Correspondence Address: CHRISTIE, PARKER & HALE, LLP, P.O. BOX 7068, PASADENA, CA, 91109-7068, US

(21) Appl. No.: 09/997,264

(22) Filed: Nov. 28, 2001

(30) Foreign Application Priority Data
Nov. 30, 2000 (FR) 0015516

(51) Int. Cl. B23P 17/00; B21K 23/00; B21D 47/00

(52) U.S. Cl. 29/897.3

(57) ABSTRACT

An installation for the circulation of part-carrying pallets (12), comprising a support frame (12) for supporting modules (14) for circulation of the pallets, and comprising at least one vertical frame arrangement (16) formed by a rigid mecano-welded structure from standard profile members (20, 22, 24, 26), as well as boxes (18) each formed by a mecano-welded structure from standard profile members (42, 46, 48) and capable of being removably fixed on respective sides of the vertical frame arrangement (16). Each of the boxes (18) comprises an upper surfaced portion (44) capable of receiving at least one module and a lower portion (40) provided with adjustable feet (50) for regulating the horizontality of the upper surfaced portion. Application to the production of parts by assembly and/or machining.

The invention concerns installations for the circulation of part-carrying pallets.

Installations of this type, also referred to as ‘flexible workshops’, are already known, which comprise a support frame for supporting modules for circulation of the pallets. Those modules can accommodate working stations and/or offer pure circulation functions. Such known installations include means for displacing the pallets in the interior of a module and from one module to another. It is known for that purpose to use in particular belts which move continuously in order to provide for the displacement of a pallet between different working stations in order to carry out a succession of operations, for example assembly and/or machining operations, on the parts which are carried on the pallets.

It is also known to provide motor-driven pallets, thus making it unnecessary to have recourse to displacement means which are integrated in the modules of the installation.

Thus, those installations make it possible to implement production of parts by a succession of operations which are carried out manually and/or automatically at the working stations.

In an installation of that type which is known from French patent No 81 17272 (publication No 2 512 723) the frame, also referred to as the supporting framework, comprises feet supporting horizontal transverse members themselves connected by bracing means, to permit the modules to be assembled in the manner of a drawer.

Those installations have been perfectly satisfactory hitherto, having regard to the relatively low speeds and levels of acceleration with which the pallets are involved.

However, with progress in robotics, the pallets are being displaced at ever increasing speeds and are also subjected to ever increasing levels of acceleration, and this gives rise to major amounts of vibration which the support frames in the prior art are not capable of effectively withstanding.

The applicants found that the support frames of the known installations were not always affording sufficient rigidity to withstand considerable vibrations, as are generated by displacement of pallets at high speeds and levels of acceleration.

Besides rigidity, a support frame of such an installation is also required to satisfy many demands.

In particular the support frame must permit the passage therethrough of different network systems, in particular for electricity and compressed air, for feeding the different modules and the items of equipment thereof.

In general terms, that requires the provision of suitable passages in the support frame, which can be detrimental to the rigidity thereof.

In addition, such a support frame must be capable of being easily erected on its installation site, permitting perfect levelling of the assembly and especially the modules.

One of the objects of the invention is consequently to provide an installation of the above-indicated type in which the support frame affords excellent rigidity for withstanding high levels of vibration, while being of a simple mechanical design configuration.

Another object of the invention is to provide such an installation in which the support frame can be assembled easily and under conditions such that the modules can be easily levelled.

Still another object of the invention is to provide such a support frame which permits the passage of different network systems, in particular for electricity and compressed air, without affecting its rigidity and its resistance to vibration.

For that purpose the invention proposes an installation for the circulation of part-carrying pallets comprising a support frame for supporting modules for the circulation of said pallets.

In accordance with a general definition of the invention the support frame of the installation comprises at least one vertical frame arrangement formed by a rigid mecano-welded structure from standard profile members, as well as boxes each formed by a rigid mecano-welded structure from standard profile members and capable of being removably fixed on respective sides of the vertical frame arrangement, each of the boxes comprising an upper surfaced portion capable of receiving at least one module and a lower portion provided with adjustable feet for adjusting the horizontality of the upper surfaced portion.

Thus the support frame of the invention essentially comprises a vertical frame arrangement and boxes fixed removably on respective sides of the vertical frame arrangement. The frame arrangement and the boxes are each in the form of a rigid mecano-welded structure obtained from standard profile members.

The frame arrangement which is disposed vertically forms the central portion of the support frame and provides an interface between the boxes. It is the boxes which rest on the ground by way of adjustable feet making it possible to ensure that the upper surfaced portion of each box is horizontal.

Indeed, the upper surfaced portion must be perfectly horizontal so that the module that it is going to receive subsequently is also perfectly horizontal.

By virtue of the very fact that it is designed on the basis of elements involving a rigid mecano-welded structure, the support frame enjoys an extreme level of rigidity and also permits a circulation of part-carrying pallets at high speeds (typically of the order of several meters per second) and levels of acceleration which are also high.

This support frame also affords the advantage of being made from standard profile members. In that respect, the preference is more particularly to use commercially available profile members of steel of type NIP (Normalised I Profile).

Profile members of that kind are commercially available, with sections of different dimensions. They are intended to be cut up into portions of desired lengths depending on the desired form of use thereof.

Hitherto such profile members have been used essentially in the building sector, but never in the sector of machines or installations of the type to which the invention relates.

Such profile members are readily available, they can be easily cut to the desired length and in addition they can be easily machined. They also afford the advantage of being very strong, in particular by virtue of their section in the form of an I made up of a central web connected to two flanges.

In a preferred embodiment of the invention the vertical frame arrangement comprises a lower horizontal profile member, an upper horizontal profile member, an intermediate horizontal profile member and two vertical profile members connected to the respective ends of the horizontal profile members.

Preferably the lower horizontal profile member extends substantially at the level of the lower portion of the boxes without however resting on the ground, the intermediate horizontal profile member extends substantially at the level of the upper surfaced portion of the boxes, while the upper profile member extends at a spacing with respect to the level of the upper portion of the boxes.

That therefore affords a frame arrangement of general rectangular shape which is further reinforced by the presence of the intermediate horizontal profile member, thus affording an extremely rigid structure.

In a preferred embodiment of the invention the vertical frame arrangement is provided on each side with six fixing plates which comprise four box fixing plates capable of being removably fixed to four homologous fixing plates forming part of a box, and two frame arrangement fixing plates capable of being removably fixed to an adjacent vertical frame arrangement.

In a preferred embodiment of the invention the six fixing plates disposed on one side of the frame arrangement extend horizontally and comprise two lower plates fixed at the level of the lower profile member of the frame arrangement, two intermediate plates fixed respectively at the level of the intermediate profile member and two upper plates fixed at the level of the upper profile member of the frame arrangement.

Preferably, the six fixing plates are co-planar and welded to the vertical frame arrangement and they comprise three plates which extend beyond one of the two vertical profile members and three plates which extend beyond the other vertical profile member.

Thus, the presence of those plates also permits fixing of another adjacent vertical frame arrangement.

In accordance with another feature of the invention the box fixing plates forming part of the frame arrangement are capable of being respectively fixed against the four homologous plates of a box by way of fixing means, of the screw type, and with the interposition of spacer plates.

In another aspect the invention concerns a process for setting up an installation as defined hereinbefore, which comprises the following operations:

a) assembling the frame arrangement on the ground;

b) placing the frame arrangement vertically and holding it vertically;

c) presenting the boxes on respective sides of the vertical frame arrangement and fixing them thereto;

d) repeating if necessary foregoing operations a) through c) for other frame arrangements and boxes to form the support frame of the installation;

e) assembling items of equipment or accessories to the support frame formed in that way; and

f) regulating the level by acting on the adjustable feet of the boxes.

This process further advantageously comprises the following supplementary operation:

g) fixing the modules on the upper surfaced portions of the boxes.

In the description hereinafter set forth solely by way of example reference is made to the accompanying drawings in which:

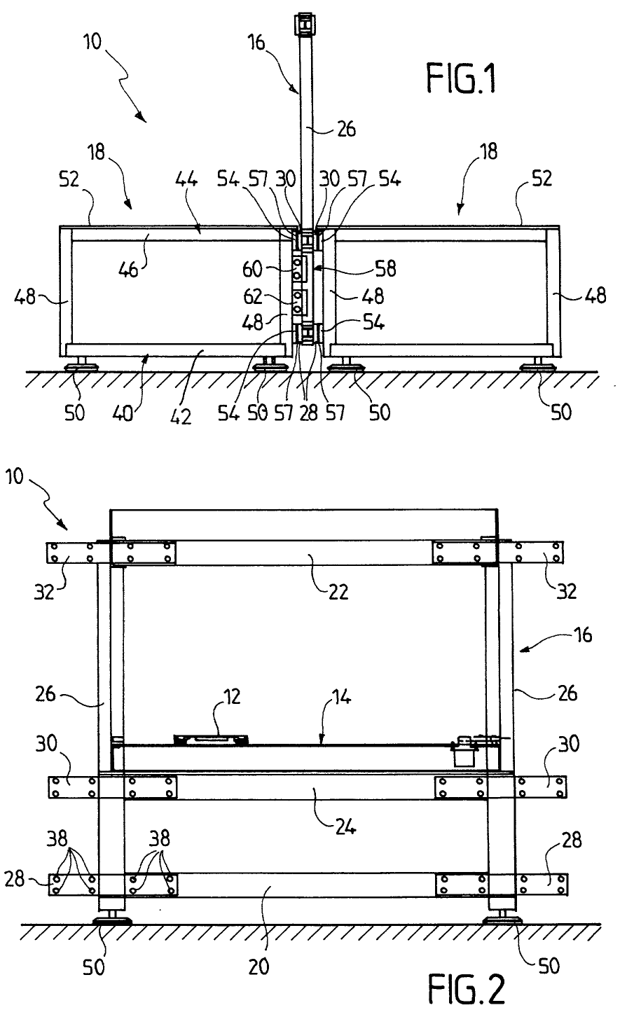

FIG. 1 is an end view of a support frame of an installation according to the invention,

FIG. 2 is a side view corresponding to FIG. 1,

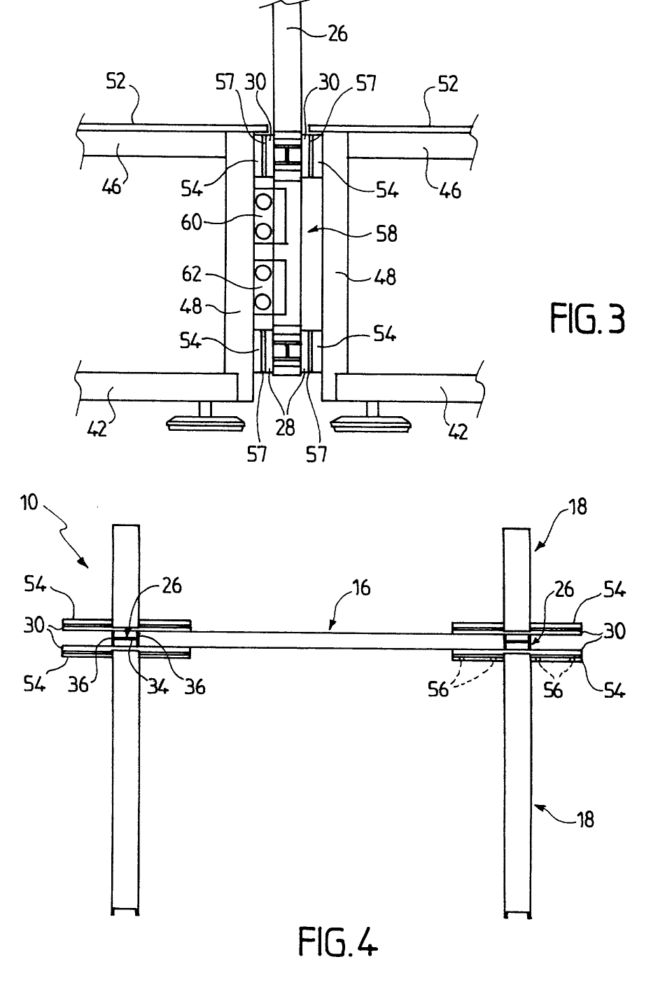

FIG. 3 is a detail shown on an enlarged scale of FIG. 1, and

FIG. 4 is a partial view from above of a support frame similar to that shown in FIGS. 1 through 3.

Reference is made firstly to FIGS. 1 and 2 showing a support frame 10 of an installation intended for the circulation of part-carrying pallets 12 on modules 14 carried by the support frame.

In the embodiment illustrated in the drawings the support frame 10 constitutes only a part of the overall support frame (or supporting framework) of the installation.

As can be seen from FIGS. 1 and 2 the support frame 10 comprises a vertical frame arrangement 16 formed by a rigid mecano-welded structure and two boxes 18 each formed by a rigid mecano-welded structure. The two boxes are capable of being removably fixed on respective sides of the vertical frame arrangement 16.

The vertical frame arrangement 16 (FIG. 2) is formed from five standard profile members which are here commercially available profile members of steel of type NIP (Normalised I Profile). Those profile members are of an I-section and are available with different types of sections and in different lengths. They can be easily cut to the desired length and machined if necessary.

The frame arrangement 16 comprises a lower horizontal profile member 20, an upper horizontal profile member 22, an intermediate horizontal profile member 24 and two vertical profile members 26 connected to the respective ends of the horizontal profile members 20, 22 and 24. In the illustrated embodiment the intermediate profile member 24 is closer to the lower profile member 20 than the upper profile member 22.

Fixed on each of the profile members 26 and on each side thereof are three fixing plates, namely a lower plate 28 at the level of the lower profile member 20, an intermediate plate 30 at the level of the intermediate profile member 24 and an upper plate 32 at the level of the upper profile member 22. Thus, each of the vertical profile members 26 receives a total of six fixing plates, namely three plates 28, 30 and 32 on one side of the vertical frame arrangement and three other plates 28, 30 and 32 on the other side of the frame arrangement. Those plates are perpendicular to the general direction of the profile member and are welded thereto, as can best be seen from FIG. 4.

The profile member 26 comprises a web 34 connected to two flanges 36 (FIG. 4). The two homologous plates, for example the two plates 32, are respectively welded to the ends of the flanges 36, and on each side of the profile member.

Each of the plates 28, 30 and 32 thus projects on respective sides of the profile member to form each time two attachments. Each of the projecting portions comprises four holes, for example four holes 38 on one side of the plate 28 and four other holes 38 on the other side of the plate 28 (FIG. 2).

The fixing plates 28, 30 and 32 are respectively fixed to the profile members 20, 22 and 24 by screws (not shown) which pass through the holes 38.

In an alternative configuration it would be possible for the plates 28, 30 and 32 to be welded directly to the profile members 20, 24 and 22 respectively, but that would destroy the dismantleability character of the frame arrangement.

As a general rule, it is preferable for the fixing plates 28, 30 and 32 to be welded to the profile members, insofar as this involves a perpendicular connection. In contrast, removable connections are preferred, in particular using screw means, when the situation involves connecting a plate to an element which extends in a parallel direction.

As can be appreciated from looking at FIG. 2, the plates 28, 30 and 32 of the two vertical profile members 26 permit fixing of the horizontal profile members 20, 22 and 24. The portions of the fixing plates which project beyond the profile members 26, beyond the frame arrangement, permit fixing of other horizontal profile members (not shown) forming part of an adjacent frame arrangement, which makes it possible to prolong the support frame as required, depending on the configuration and the dimensions of the desired installation.

Each of the boxes 18 is also formed by a mecano-welded structure from standard profile members and in particular commercially available profile members of steel of type NIP, just like the frame arrangement 16.

Each of the boxes comprises a lower portion 40 formed by four profile members 42 arranged to form a rectangular frame arrangement and an upper portion 44 formed by four rectangular profile members 46 arranged to form a rectangular frame arrangement which is in homologous relationship with the previous one. The lower portion 40 and the upper portion 44 are connected together by four vertical profile members 48. That thus constitutes a box in the general shape of a parallelepiped, the edges of which are defined by profile members which are advantageously welded together to define a rigid box.

The lower portion 40 is provided with four adjustable feet 50 while the upper portion 44 is surfaced. For that purpose it comprises a surface plate 52 intended to receive a module 14.

Each of the boxes 18 is provided with four fixing plates 54 which constitute plates homologous with the four fixing plates (two plates 28 and two plates 30) disposed on one side of the frame arrangement 16.

The plates 54 are horizontal and co-planar and welded to the box, that is to say to the vertical profile members of the box, to define as hereinbefore a welded connection for perpendicular elements.

The four fixing plates 54 of the box are provided to be screwed against the two lower plates 28 and the two intermediate plates 30 disposed on one side of the frame arrangement 16. Those fixing plates are of substantially the same dimensions and come into mutually corresponding relationship. For that purpose the fixing plates 54 of the box are also provided with four holes 56 (FIG. 4) which are homologous with the holes 38 of the fixing plates of the vertical frame arrangement. In FIG. 4 the boxes 18 (shown in part) are of different depths, in contrast to the boxes in FIGS. 1 and 2 which are of the same depth.

The lower horizontal profile member 20 extends substantially at the level of the lower portion 40 of the boxes without however resting on the ground while the intermediate horizontal profile member 24 extends substantially at the level of the upper surfaced portion 44 of the boxes and the upper profile member extends at a spacing with respect to the level of the upper surfaced portion 44 of the boxes.

As can be seen from FIGS. 1, 3 and 4, each of the box fixing plates 54 is fixed to a homologous plate 28 or 30 of the frame arrangement with the interposition of one or more spacer plates 57. In that way, it is possible to provide a free space 58 between the box and the frame arrangement to permit the passage of network systems 60 and 62 which can be electrical cables or conduits or conduits intended to carry compressed air.

To assemble the support frame of the installation, the procedure begins firstly with assembling the frame arrangement on the ground from two vertical profile members 26 and three horizontal profile members 20, 22 and 24. The two vertical profile members 26 have each previously been fitted with the fixing plates 28, 30 and 32 which were welded in the factory. The components of the frame arrangement are assembled by screw means.

Then, the frame arrangement is placed vertically and it is held vertically to permit presentation of the boxes 18 on respective sides of the frame arrangement. It will be noted that the frame arrangement has to be held above the ground, that is to say the lower profile member 20 is disposed at a spacing from the ground. The four fixing plates of a box are assembled to the homologous plates of the frame by screwing with the interposition of the appropriate spacer plates.

The foregoing operations are possibly repeated to fix other frame arrangements and boxes and constitute the complete support frame of the installation. Then, items of equipment or accessories are fitted to the support frame formed in that way, for example the network systems 60 and 62 are fitted thereto. At this stage, the level is adjusted by acting on the adjustable feet of the boxes in such a way that the upper surfaced portions 44 of the boxes are perfectly horizontal.

Then, the procedure involves fitting the modules 14 which serve to convey the pallets 12. Those modules can receive working stations which are manual or automatic, and/or afford pure circulation functions. Displacement of the pallets 12 can be effected either by displacement means forming part of the modules themselves such as belt means, or by motor-drive means which are integrated in the pallets.

That therefore provides a support frame involving a rigid structure which can be easily implemented from standard commercially available elements and which can be easily assembled and adjusted on the site at which the installation is set up.

Such a support frame retains its rigidity even with pallets which are displaced at high speeds and at high levels of acceleration.

The invention applies generally to the installations, sometimes also referred to as ‘flexible workshops’, which are intended for the assembly and/or machining of parts carried by pallets.

1. An installation for the circulation of part-carrying pallets (12), comprising a support frame (12) for supporting modules (14) for circulation of the pallets,
characterised in that the support frame (10) comprises at least one vertical frame arrangement (16) formed by a rigid mecano-welded structure from standard profile members (20, 22, 24, 26), as well as boxes (18) each formed by a mecano-welded structure from standard profile members (42, 46, 48) and capable of being removably fixed on respective sides of the vertical frame arrangement (16), and that each of the boxes (18) comprises an upper surfaced portion (44) capable of receiving at least one module (14) and a lower portion (40) provided with adjustable feet (50) for adjusting the horizontality of the upper surfaced portion.

2. An installation as set forth in claim 1 characterised in that the standard profile members (20, 22, 24, 26) of the vertical frame arrangement (16) and the standard profile members (42, 46, 48) of the boxes (18) are commercially available profile members of steel of type NIP.

3. An installation as set forth in claim 1 characterised in that the vertical frame arrangement (16) comprises a lower horizontal profile member (20), an upper horizontal profile member (22), an intermediate horizontal profile member (24) and two vertical profile members (26) connected to the respective ends of the horizontal profile members (20, 22, 24).

4. An installation as set forth in claim 2 characterised in that the lower horizontal profile member (20) extends substantially at the level of the lower portion (40) of the boxes without however resting on the ground, that the intermediate horizontal profile member (24) extends substantially at the level of the upper surfaced portion (44) of the boxes, and that the upper profile member (22) extends at a spacing with respect to the level of the upper surfaced portion (44) of the boxes.

5. An installation as set forth in one of claims 3 and 4 characterised in that the vertical frame arrangement (16) is provided on each side with six fixing plates (28, 28, 30, 30, 32, 32) which comprise four box fixing plates (28, 28, 30, 30) capable of being removably fixed to four homologous fixing plates (54) forming part of a box (18) and two frame arrangement fixing plates (32) capable of being removably fixed on an adjacent vertical frame arrangement.

6. An installation as set forth in claim 5 characterised in that the six fixing plates (28, 28, 30, 30, 32, 32) disposed on one side of the frame arrangement (16) extend horizontally and comprise two lower plates (28) fixed at the level of the lower profile member (20) of the frame arrangement, two intermediate plates (30) fixed at the level of the intermediate profile member (24) and two upper plates (32) fixed at the level of the upper profile member (22) of the frame arrangement.

7. An installation as set forth in one of claims 5 and 6 characterised in that the six fixing plates (28, 28, 30, 30, 32, 32) are co-planar and welded to the vertical frame arrangement (16) and comprise three plates (28, 30, 32) which extend beyond one of the two vertical profile members (26) and three plates (28, 30, 32) which extend beyond the other vertical profile member (26).

8. An installation as set forth in one of claims 5 through 7 characterised in that the box fixing plates (28, 28, 30, 30) forming part of the frame arrangement (16) are capable of being fixed respectively against the four homologous plates (54) of a box by way of fixing means of the screw type and with the interposition of spacer plates (57).

9. An installation as set forth in one of claims 5 through 8 characterised in that the fixing plates (54) of the box (18) are co-planar and welded to the box.

10. An installation as set forth in one of claims 1 through 9 characterised in that the box (18) comprises four profile members (42) forming the lower portion (40) and supporting the adjustable feet (50), four profile members (46) forming the upper surfaced portion (44) and four vertical profile members (48) connecting the lower portion (40) and the upper surfaced portion (44).

11. A process for assembling an installation as set forth in one of the preceding claims, comprising the following operations:
a) assembling the frame arrangement (16) on the ground;
b) placing the frame arrangement vertically and holding it vertically;
c) presenting the boxes (18) on respective sides of the vertical frame arrangement (16) and fixing them thereto;
d) repeating if necessary foregoing operations a) through c) for other frame arrangements and boxes to form the support frame (10) of the installation;
e) assembling items of equipment or accessories (60, 62) to the support frame formed in that way; and
f) regulating the level by acting on the adjustable feet (50) of the boxes (18).

12. A process as set forth in claim 11 characterised in that it comprises the following supplementary operation:
g) fixing the modules (14) on the upper surfaced portions (44) of the boxes (18).
